(19) United States
(12) Patent Application Publication
(10) Pub. No.: US 2018/0304978 A1
(43) Pub. Date: Oct. 25, 2018

(54) CUSTOMIZABLE LIGHTING SYSTEM FOR RECREATIONAL FLOTATION DEVICES

(71) Applicant: Aqua-Leisure Industries, Inc., Avon, MA (US)

(72) Inventors: Scott R. de Grasse, Marshfield, MA (US); Gregory J. Autore, Spring Valley, OH (US)

(73) Assignee: Aqua-Leisure Industries, Inc., Avon, MA (US)

(21) Appl. No.: 15/962,222

(22) Filed: Apr. 25, 2018

Related U.S. Application Data
(60) Provisional application No. 62/489,725, filed on Apr. 25, 2017.

(51) Int. Cl. B63C 9/20; H05B 37/02; F21L 4/02

(52) U.S. Cl. CPC B63C 9/20; F21S 10/02; F21L 4/027; H05B 37/0272

(57) ABSTRACT

An inflatable flotation device includes one of more pockets for receiving and retaining a lighting element or elements. The lighting elements may be readily inserted into and removed from the pockets so that the user may select the location of the elements. The user may also choose the direction of the light beam emanating from each element. The lighting elements are water-tight in construction and fully submersible, and may be controlled remotely by low-frequency signals that allow the user to selectively activate each element and control the color of its light beam.

### RELATED APPLICATION

This application claims priority under 35 U.S.C. Section 119(e) to U.S. Provisional Application Ser. No. 62/489,725 entitled “CUSTOMIZABLE LIGHTING SYSTEM FOR INFLATABLE FLOATS,” filed on Apr. 25, 2017, which application is hereby incorporated by reference in its entirety for all purposes.

### SUMMARY OF THE INVENTION

Inflatable beach and pool floats are extremely popular recreational devices. They come in numerous shapes and colors, providing an eye-catching and entertaining addition to the user's experience. The instant invention adds to that enjoyment by providing a system that allows a user to selectively add illumination to the flotation device.

A flotation device in accordance with on aspect of the instant invention includes a plurality of pockets for receiving and retaining lighting elements. The lighting elements may be readily inserted into and removed from the pockets so that the user may select the locations of the elements. The lighting elements are preferably water-tight in construction and fully submersible, and may be controlled remotely by low-frequency signals that allow the user to selectively activate each element and control the color of its light beams.

### DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 depicts a flotation device with lighting elements.

FIG. 2 depicts the lighting element poised above a pocket in the device

FIG. 3 depicts the lighting element received by and retained in the pocket/

### DETAILED DESCRIPTION OF THE INVENTION

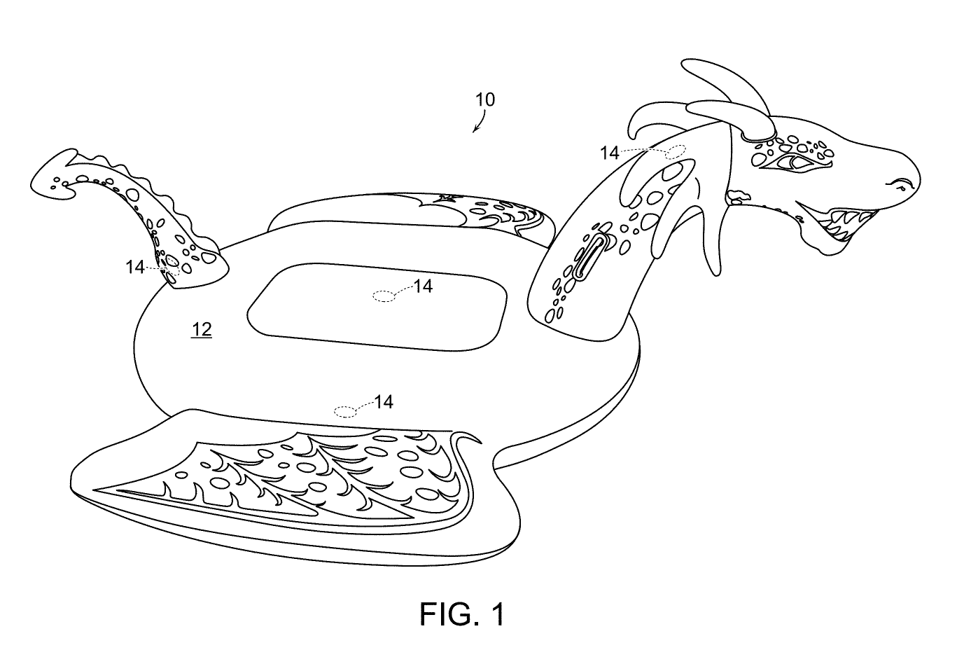

A flotation device 10 in the form of a dragon is depicted in FIG. 1. Lighting elements 14 are held in pockets formed at the surface of the device, and emit beams of light, either outwardly or inwardly. In this aspect of the invention, the device 10 comprises an inflatable PVC bladder constructed in conventional fashion.

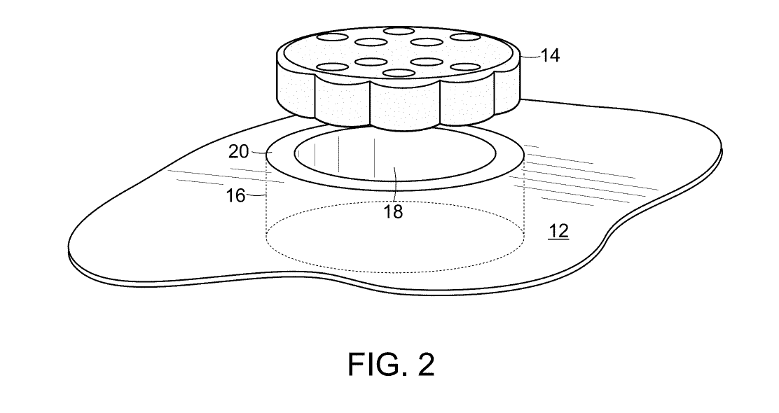

Turning to FIG. 2, a commercially available, submersible lighting element 14 in the shape of a puck provides light beams emanating from one of its circular sides. Circuitry within the puck interacts with remote control circuitry in a hand-held unit that allows the user to control, by low-frequency signals, each lighting element individually to selectively activate each element and control the color of its light beam. Suitable lighting elements with remote control unit may be obtained from, for example, Shenzhen Greatfavonian Electronic Co. Ltd., 5F, Tongfuyu Industrial Park, Lezhujiao, Zhoushi Road, Baoan District, Shenzhen, Guangdong, China 518102. The lighting element has a clear injection-molded plastic case enclosing a condenser for each lighting unit. The lighting element is sealed and water-tight. Power consumption of each element is 1.35 W (4.5 v DC, AAA battery λ3).

FIG. 2 depicts a pocket 16 of clear or prismatic PVC welded to PVC layer 12 in conventional fashion, and receives a lighting element 14. A strengthening ring 20 of PVC material is welded around the outer circumference of pocket 16, and projects inwardly to create aperture 18. Because the diameter of lighting element 14 is slightly larger than the diameter of aperture 18, the element 14 will be retained within pocket 16 until the consumer decides to remove the element. The air pressure within the device will assist in securing the lighting element 14 within the pocket, and it will typically be necessary to partly deflate the device 10 at least partially in order to insert or remove the lighting element 14.

In one aspect of the invention, aperture 18 is approximately 57 mm in diameter. Pocket 16 is about 80 mm in diameter and 40 mm deep. The puck-shaped lighting element 14 is approximately 70 mm in diameter and 25 mm high.

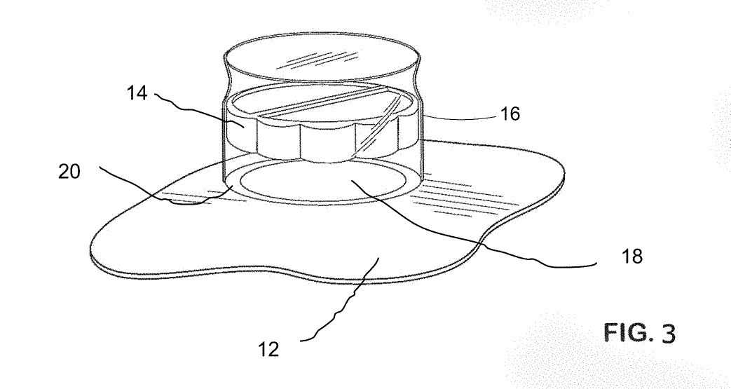

FIG. 3 provides a view of the lighting element located within the pocket, as viewed from within the device. Lighting element 14 is retained within the pocket 16, and may be removed through aperture 18. As indicated above, reinforcing rim 20, of a diameter less than that of lighting element 14, prevents the element from escaping the pocket 16 on its own.

From the description of at least one embodiment of the present disclosure, various alterations, modifications, and improvements will readily occur to those skilled in the art. Such alterations, modifications, and improvements are intended to be within the scope and spirit of the disclosure. Accordingly, the foregoing description is by way of example only and is not intended to be limiting.

While several embodiments of the present invention have been described and illustrated herein, those of ordinary skill in the art will readily envision a variety of other means and/or structures for performing the functions and/or obtaining the results and/or one of more of the advantages described herein, and each of such variations and/or modifications is deemed to be within the scope of the present invention. More generally, those skilled in the art will readily appreciate that all parameters, dimensions, materials, and configurations described herein are mean to be exemplary and the actual parameters, dimensions, materials and/or configurations will depend upon the specific application or applications for which the teachings of the present invention is/are used. Those skilled in the art will recognize or be able to ascertain using no more than routine experimentation, many equivalents to the specific embodiments of the invention described herein. It is therefore to be understood that the foregoing embodiments are presented by way of example only and that, with the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

I claim:

1. A flotation device comprising:
a buoyant body member;
at least one light-emitting element;
a pocket formed in said body member, said pocket having an opening to allow receipt of said light-emitting element in said pocket.

2. The device of claim 1 having a plurality of pockets to allow selective placement of said light-emitting element in one of the pockets to provide different lighting effects as desired.

3. The device of claim 2 wherein the light-emitting element includes circuitry to allow remote control of the brightness and/or color of the light emitted by the element.

4. The device of claim 2, wherein said buoyant body member comprises an inflatable bladder.

5. The device of claim 4 wherein the light-emitting element includes circuitry to allow remote control of the brightness and/or color of the light emitted by the element.
